(19) United States
(12) Patent Application Publication
(10) Pub. No.: US 2008/0157957 A1
(43) Pub. Date: Jul. 3, 2008

(54) Wall Finding For Wireless Lighting Assignment

(75) Inventors: Stephen M. Pitchers, Redhill (GB); Paul R. Simons, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,875

(22) PCT Filed: Mar. 8, 2006
(86) PCT No.: PCT/IB2006/050717

§ 371 Date: Sep. 6, 2007

(30) Foreign Application Priority Data
Mar. 11, 2005 (EP) 05101928.9

(51) Int. Cl. G08B 1/08; H04Q 7/00; H05B 37/02; G01S 5/02

(52) U.S. Cl. 340/539.1

(57) ABSTRACT

A method for determining the location of partition walls within a building uses a wirelessly interconnected network of nodes to determine relative spatial positions of selected nodes using (i) received signal strength indication (RSSI) values and time of flight (ToF) values, both indicative of a distance of separation between two communicating nodes. A first map of the network topology is derived from the RSSI values and a second map of the network topology is derived from the ToF values. The RSSI values are affected by building partition walls whereas the ToF values are relatively unaffected by partition walls. A comparison of the first and second maps is used to determine the location of partition walls within the building.

The present invention relates to methods and apparatus for commissioning wireless lighting nodes in a building, and in particular to assigning each of a plurality of lighting nodes or luminaires to respective switching control nodes.

Use of wirelessly controlled lighting units or luminaires in buildings (hereinafter referred to generally as ‘lighting nodes’) is becoming increasingly popular, since it can substantially reduce lighting installation costs. Physical wires between the lighting switches or actuation sensors (hereinafter referred to as ‘switching control nodes’) and the lighting nodes are replaced by wireless (e.g. radio) links. All lighting nodes and switching control nodes need only be connected to an appropriate power source and need not be electrically connected. Each luminaire includes a wireless receiver and each switching control node includes a wireless transmitter. During commissioning, each luminaire is identified and assigned to a particular switching control node or nodes. Typically, multiple luminaires are assigned to a particular switching control node, e.g. to operate multiple luminaires within one large room.

A significant disadvantage that remains in the prior art is that the commissioning process is time consuming and can interfere with the ability of other contractors on a building site to proceed with their work. For example, the commissioning electrician must typically selectively actuate luminaires or groups of luminaires throughout the building in order to work out which lighting nodes should be assigned to which switching control points. Other parts of the building could be in darkness while this operation continues. Another disadvantage is that the task of node assignments is a skilled job requiring the services of a lighting control specialist.

Typically, lighting nodes are grouped for assignment to switching control nodes according to a room in which they are based.

A number of prior art documents (e.g. WO 01/97466, and Patwari et al: “Relative Location Estimation in Wireless Sensor Networks”, IEEE Transactions on Signal Processing, vol. 51, no. 8, August 2003) have addressed problems related to spatially locating wireless nodes in networks, but none of these has specifically addressed the problems of automatically assigning lighting nodes to switching control nodes.

Specifically, US patent application 2002/0122003 and Qi et al: “On relation among Time Delay and Signal Strength based Geolocation Methods”, Globecom 2003 describe methods and apparatus for locating objects that incorporate wireless transceivers, within a building, using ‘time-of-flight’ (ToF) or ‘time-difference-of-arrival’ (TDOA) techniques and/or received signal strength indication (RSSI) techniques and/or direction-of-arrival (DoA) techniques to triangulate the position of the objects. Multiple (‘hybrid’) such techniques are used to minimise or eliminate the effects of errors on one type of measurement.

It is an object of the present invention to overcome or mitigate at least some of the disadvantages indicated above.

According to one aspect, the present invention provides a method for determining the location of partition walls within a building, using a wirelessly interconnected network of nodes, comprising the steps of:

establishing wireless communication between the nodes to determine relative spatial positions of selected nodes using received signal strength indication (RSSI) values indicative of a distance of separation between two communicating nodes, and generating a first map of the network topology therefrom;

establishing wireless communication between the nodes to determine relative spatial positions of selected nodes using time of flight (ToF) values indicative of a distance of separation between two communicating nodes, and generating a second map of the network topology therefrom; and

comparing the first and second maps to determine the location of partition walls within the building.

According to another aspect, the present invention provides an apparatus for determining the location of partition walls within a building, using a wirelessly interconnected network of nodes, comprising:

a first map generator for receiving from a plurality of nodes in the network a plurality of received signal strength indication (RSSI) values each indicative of a distance of separation between two communicating nodes established using wireless communication between the nodes, and generating a first map of the network topology therefrom;

a second map generator for receiving from a plurality of nodes in the network a plurality of time of flight (ToF) values each indicative of a distance of separation between two communicating nodes established using wireless communication between the nodes, and generating a second map of the network topology therefrom; and

a comparator module for comparing the first and second maps to determine the location of partition walls within the building.

Embodiments of the present invention will now be described by way of example and with reference to the accompanying drawings in which:

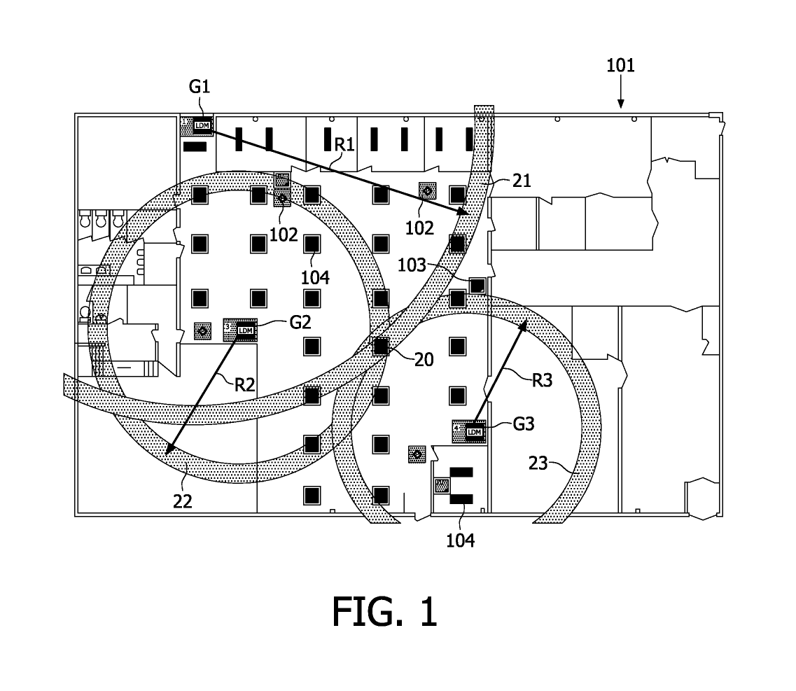

FIG. 1 shows a schematic building plan giving the location of luminaires, switching control units and network gateways and illustrating the triangulation principles used to locate a luminaire position;

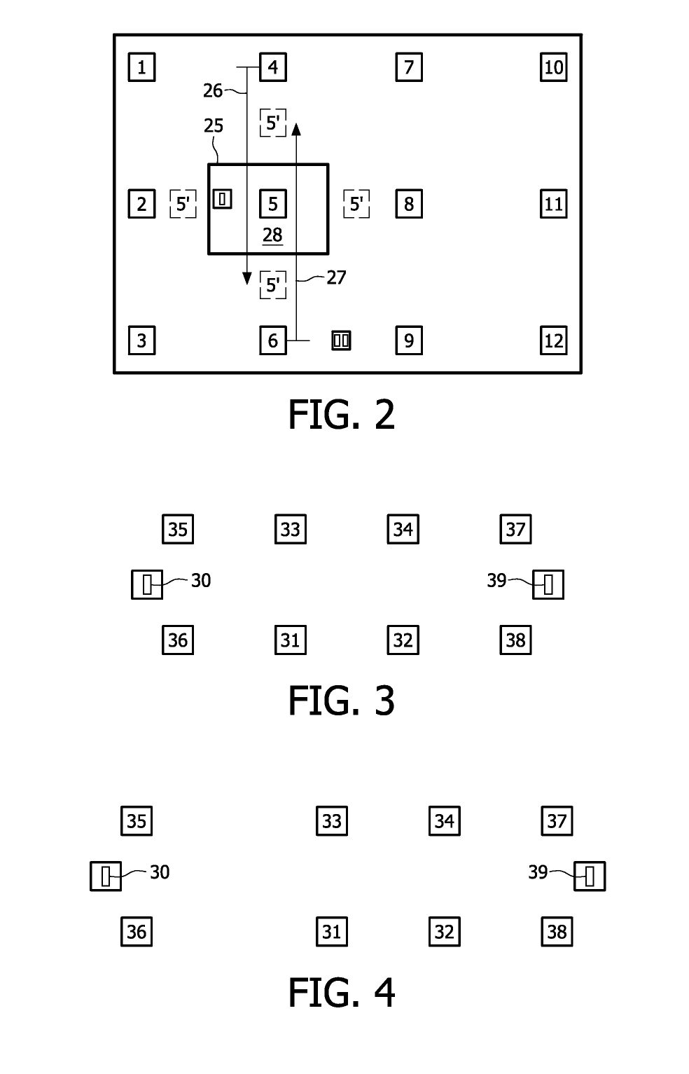

FIG. 2 shows a schematic plan view of a lighting installation topology as perceived by both RSSI ranging and ToF ranging;

FIG. 3 shows a schematic plan view of a lighting installation topology as perceived by ToF ranging;

FIG. 4 shows a schematic plan view of the lighting installation of FIG. 3 as perceived using RSSI ranging;

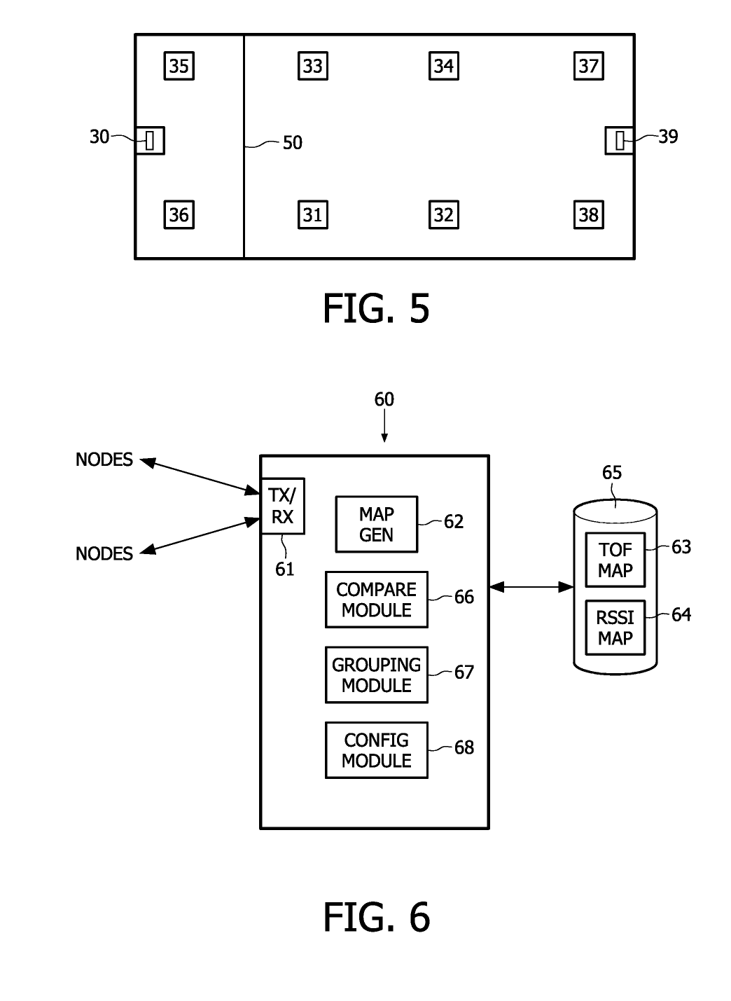

FIG. 5 shows a schematic plan view of the actual ground plan of the lighting installation of FIGS. 4 and 5; and

FIG. 6 shows a schematic diagram of a controlling node for assigning lighting nodes to switching control nodes according to the positions of nodes determined according to ToF ranging data and RSSI ranging data.

A number of techniques are available for determining the spatial position of wirelessly connected nodes in a network. One such example is the signal ‘time of flight’ (ToF) approach, in which the time taken for signals passing between nodes is used to estimate the distance between the nodes. This provides a very accurate estimate of distances between nodes, and is relatively immune to physical obstructions between the signalling nodes. Therefore, it is a popular method for determining distance between nodes. An alternative technique is to use received signal strength indication (RSSI) measurements to provide an estimate of the distance between two nodes. As the received signal strength tends to decline with increasing distance, the RSSI reading can be converted into a practical estimate of range.

The RSSI technique is less accurate than ToF ranging, and is generally held to be less useful for automatic position finding. One characteristic of RSSI ranging is that it is affected, in indoor situations, by absorption and dispersion by walls and other partitions within the building. However, the inventors have recognised that this apparent disadvantage can actually be a positive advantage in certain circumstances.

By comparing the topology of a network as determined by time-of-flight ranging with the topology of the network as determined by RSSI ranging, it is possible to determine the location of walls, partitions and other objects interposed between the various nodes. This can be useful information in the commissioning of a lighting system when it is necessary to determine which lighting nodes should be controlled by which switching nodes. Throughout the present specification, the expression ‘partition walls’ is intended to encompass all dividers of space within a building, the presence of which dividers can potentially be determined by comparing ToF ranging signals and RSSI ranging signals. In the present specification, the expression ‘time-of-flight’ ranging is intended to encompass the comparable technique of ‘time-difference-of-arrival’ (TDOA) ranging.

FIG. 1 shows a floor plan for a building 101 in which a number of luminaires 104, switching control units 102, 103 and gateway devices are identified within one room of the building. Of course, such a floor plan would ordinarily also extend to other rooms on that floor, and to other rooms in the building. Each of the luminaires 104 may be connected to a common power supply, to different power supplies, or to different phases of a power supply and also may be connected to a building management system (not shown) by either a wired or wireless bus. Preferably, each of the luminaires and switching control units is in wireless communication with at least one gateway node G1, G2, G3. The gateway nodes are typically in wired communication directly with a building management system. The switching control units 102, 103 may be of any suitable type to effect control over associated luminaires, such as motion sensors or presence detectors 102, and dimmer controllers 103. Of course, the switching control units 102, 103 may also be other types (e.g. thermostats, etc) adapted for use with other types of building service devices, such as heaters and air conditioning units.

To begin the commissioning process at least three clearly identified wireless devices of known position (absolute or relative) may be used to provide the fixed reference points. These three devices may be the gateway devices G1, G2, G3 although any three devices could be selected. These devices all need to be in range of at least one luminaire 104 etc to start the process. Signals can be sent giving the position of each sending device and allowing the receiving device to measure its range using time-of-flight. Using three such measurements allows the receiving device to determine its position using well known triangulation techniques.

For example, luminaire 20 has detected three such signals depicted as ranges R1, R2 and R3 respectively transmitted from gateways G1, G2, G3. The luminaire device 20 uses these ranges and the transmitted positions of the gateway devices G1, G2, G3 to triangulate its own position from the intersection of the respective loci 21, 22, 23 of signal ranges R1, R2, R3. This information can be compiled with the device's unique identity (e.g. IEEE address or network local address), specific device type and its calculated position and sent back to the building management system over the network.

Each receiving device also determines its position from the three signals depicted as ranges R1, R2 and R3 using received signal strength indications. Thus, each device obtains information suitable to triangulate its position by two separate methods, firstly ToF ranging, and secondly RSSI ranging.

Once the position of one wireless device is successfully identified, it can be used as a fixed reference point of known position to help identify the positions of other wireless devices if any exist beyond the wireless transmission range of the gateways G1, G2, G3. The process can be used to propagate over the level of a building to commission each light, sensor and switch.

When attempting to assign switching control devices to luminaires, it is important to know the topology of the lighting array and the relative position of the switches or presence detectors compared with the luminaires they are to control. It is also very important to know where the walls of the room are. In particular, it is necessary to know on which side of a wall a switch is located, so that the switch can be assigned the luminaires inside the correct room.

RSSI measurements can be used to estimate the range between wireless nodes due to the fact that the signal strength diminishes over distance. However, the signal strength is also reduced by the effect of walls, due to dispersion and absorption, causing the reported range to be greater than the true figure. This is generally helpful for this application, as nodes within the same room will naturally appear to be closer together than nodes on the other side of walls and this helps in deciding which nodes should be grouped together.

However, there are some arrangements that would cause great difficulty for this technique. Imagine an installation that might be found in a typical high rise office block, with office space containing a number of lighting nodes 1 . . . 4 and 6 . . . 12 surrounding a central stairwell 28 as shown in FIG. 2. An attempt to use RSSI ranging alone would run into trouble because the walls 25 surrounding the nodes within the stairwell (e.g. node 5) would make these nodes appear to be further away from the other nodes than they really are: the apparent positions of the node 5 are indicated by “virtual” nodes 5′ shown in dashed outline. However, they cannot simultaneously be perceived to be both further south from their true location from the perspective of the northernmost nodes (e.g. node 4, range indicated by line 26) and further north from the perspective of the southernmost nodes (e.g. node 6, range indicated by the line 27). A position finding algorithm that relies solely on RSSI ranging will not readily be able to resolve this situation.

In contrast to RSSI ranging, positions derived from time of flight (ToF) measurements are not effected by walls and the reported range is consequently more accurate, even in the presence of walls 25. However, ToF does not help with finding the locations of walls 25, which is a disadvantage. It is important to know where the walls are in relation to the switches and luminaires as the automatic commissioning system must be able to group nodes according to the room in which they are located.

The solution of the present invention is to use range readings from both RSSI and ToF measurements and then compare the results. Where there is a wall between a particular pair of nodes (e.g. nodes 4 and 5, or nodes 5 and 6), there will be a mismatch in the reported RSSI range and the ToF range indicating that the signal has passed through an object such as a wall or building partition.

Comparing the RSSI measurement with the more accurate range given by the ToF reading may also determine when a switching control unit (e.g. 102, 103) is on the opposite side of a wall because the wall itself will absorb some of the signal strength. Even should any luminaires in another room be physically closer than any of the luminaires in the same room as a switching control unit, the RSSI reading will show them to be further away. Knowing the position of the walls allows the correct assignments to be made.

An as example embodiment, consider a complicated office layout where a large floor area has been divided into smaller offices by the addition of partition walls.

In order to achieve the ranging accuracy required for making correct assignments of luminaires to switches, time of flight ranging is used to derive the topology of all the wireless nodes across the floor plan. However to ensure that switches are not accidentally assigned to luminaires in another room, RSSI ranging is also employed in order to detect the location of the partition walls.

By comparing the ToF and RSSI measurements, the presence of walls can be readily inferred. This will allow assignments to be made with far fewer errors that would have been the case when using RSSI ranging or ToF ranging alone. FIG. 3 shows the locations of a set of luminaires 31 . . . 38 and switches 30, 39 derived from ToF information alone. In the absence of information to the contrary, an assignment algorithm is likely to divide the luminaires into two groups of four: i.e. nodes 31, 33, 35 and 36 assigned to the left hand switch 30 and nodes 32, 34, 37, 38 to the right hand switch 39.

When the information from RSSI measurements is assessed, as shown in FIG. 4, it appears that nodes 35 and 36 are further away from other luminaires than reported by the ToF measurements. This suggests a different grouping of luminaires. When the RSSI readings are compared with the ToF measurements, it is possible to produce a combined topology, as shown in FIG. 5. In this topology, the wall position 50 has been inferred from the differences in range reported by the two sets of measurements. The spatial separation of some nodes in the RSSI map is greater than the spatial separation of those nodes in the ToF map. This provides the assignment algorithm with the information needed to group the luminaires according to the room in which they are located and assign the correct switch to each group.

If ToF ranging only was used, it would not be possible to tell reliably which lights to assign to which switch. If RSSI ranging only was used, the fact that luminaires are displaced from their true position might also cause luminaires to be misallocated, as can be seen from FIG. 2.

With reference to FIG. 6, a central controlling node 60 includes a transceiver 61 for receiving information on location of lighting nodes and control nodes in the network, and a map generator module 62 for generating a network topographic maps therefrom. The generated maps comprise a first map 63 as determined according to ToF ranging and a second map 64 determined according to RSSI ranging. The maps 63, 64 are stored in memory 65. A comparator module 66 compares the node groupings as indicated by the first and second maps 63, 64 to locate the positions of building walls or partitions. A grouping module 67 uses these differences to determine how the lighting nodes should be grouped by room. A configuration module 68 then issues, using transceiver 31, configuration signals to appropriate lighting nodes and to relevant switching control nodes to thereby allocate appropriate lighting nodes to respective switching control nodes. The functions of central controlling node 60 could be located within a designated lighting node or a designated switching control node, or in a dedicated central controller, such as a building management system.

Preferably, the functions of the map generator module 62, the comparator module 66, the grouping module 67 and the configuration module 68 are performed by a suitably programmed microprocessor.

If the number of lighting nodes determined by the system to be in the same room is larger than a certain number of lighting nodes, the nodes may be divided between two or more switching control nodes in that room, according to some logical grouping. For example, some of the first group of lighting nodes (corresponding to a first lighting zone) may be programmed to be responsive to one switching control node and others of the first group of lighting nodes (corresponding to a second lighting zone) may be programmed to be responsive to another switching control node.

The task of programming or configuring allocations of switching control nodes to respective lighting nodes can be performed by any one of: (i) programming selected switching control nodes to control (i.e. send signals to) specified lighting nodes; (ii) programming selected lighting nodes to be responsive to signals from specified switching control nodes; or (iii) a combination of (i) and (ii) above.

It will be recognised from the above that the activities of determining relative locations of the lighting nodes and allocating an appropriate switching control node may be performed on a distributed or global basis. In other words, a central controlling node 60 may be used to receive all topology information and assign specific lighting nodes to appropriate switching control nodes. Alternatively, each switching control node 30, 39 may determine and assign its own lighting nodes as discussed above.

The preferred embodiments have been described using three ‘reference’ wireless devices of either known absolute spatial position or known relative spatial position. However, it will be understood that the three reference devices may be of unknown position and may be used to start the process of creating a relative map. For example, a first reference node may be allocated a two-dimensional position of (0,0). The second reference node may be then allocated a two-dimensional position of (range, 0) or (0, range) where the range is the distance between the first two reference nodes. The third reference node may be allocated a position determined by the ranges from the first and second reference nodes. All other nodes may then be positioned relative to these three reference nodes.

The invention has been particularly described in connection with the installation and commissioning of wirelessly controlled lighting nodes in a building. It will be noted that a similar principle can also be applied to other forms of wirelessly controllable devices installed within a building that might need to be grouped for control by remotely located switching control nodes, on a room by room basis, such as air conditioning or other ventilation units, window blinds or curtains and the like. The expression ‘building service device’ as used herein is therefore intended to encompass all such remotely controllable electrical devices installed in a building.

Other embodiments are intentionally within the scope of the accompanying claims.

1. A method for determining the location of partition walls (25, 50) within a building (101), using a wirelessly interconnected network of nodes (102, 103, 104, G1, G2, G3), comprising the steps of:
establishing wireless communication between the nodes to determine relative spatial positions of selected nodes using received signal strength indication (RSSI) values indicative of a distance of separation between two communicating nodes, and generating a first map (64) of the network topology therefrom;
establishing wireless communication between the nodes to determine relative spatial positions of selected nodes using time of flight (ToF) values indicative of a distance of separation between two communicating nodes, and generating a second map (63) of the network topology therefrom; and
comparing the first and second maps to determine the location of partition walls within the building.

2. The method of claim 1 further including the step of using said determined location of partition walls (50) to assign each node (31 . . . 38) to a respective room of the building in which the node lies.

3. The method of claim 2 in which the nodes include building service device nodes (1 . . . 12, 31 . . . 38) and switching control nodes (30, 39).

4. The method of claim 3 further including the step of allocating each service device node to at least one associated switching control node based on the respective room assignments.

5. The method of claim 4 in which the step of allocating includes the step of programming each node of a first group of service device nodes (31 . . . 34, 37, 38) in a first room to respond to a first switching control node (39) and programming each of node of a second group of service device nodes (35, 36) in a second room to respond to a second switching control node (30).

6. The method of claim 4 in which the step of allocating includes the step of programming a first switching control node (39) to control each node of a first group of service device nodes (31 . . . 34, 37, 38) in a first room and programming a second switching control node to control each node of a second group of service device nodes (35, 36) in a second room.

7. The method of claim 5 in which the first switching node (39) is located in the first room and the second switching node (30) is in the second room.

8. The method of claim 1 in which the step of determining the location of partition walls (25, 50) comprises determining where the spatial separation of nodes indicated by the first map (64) is greater than the spatial separation of nodes indicated by the second map (63).

9. The method of claim 1 in which the step of establishing wireless communication between nodes comprises measuring RSSI and ToF values for signals respectively between a designated node and each one of a plurality of other nodes within communication range of the designated node to determine a distance of separation between the designated node and each of the plurality of other nodes.

10. The method of claim 1 in which each building service device nodes comprises a luminaire (104), and each switching control node comprises an on-off switch (30, 39), a dimmer controller (103), a motion sensor, or a presence sensor (102).

11. The method of claim 1 in which each building service control device comprises any of a heating unit, a ventilation unit, or an air conditioning unit.

12. Apparatus for determining the location of partition walls (25, 50) within a building (101), using a wirelessly interconnected network of nodes, comprising:
a first map generator (62) for receiving from a plurality of nodes in the network a plurality of received signal strength indication (RSSI) values each indicative of a distance of separation between two communicating nodes established using wireless communication between the nodes, and generating a first map (64) of the network topology therefrom;
a second map generator (62) for receiving from a plurality of nodes in the network a plurality of time of flight (ToF) values each indicative of a distance of separation between two communicating nodes established using wireless communication between the nodes, and generating a second map (63) of the network topology therefrom; and
a comparator module (66) for comparing the first and second maps to determine the location of partition walls (25, 50) within the building.

13. The apparatus of claim 12 further including a microprocessor adapted to use the determined location of partition walls to assign each node (31 . . . 38) to a respective room of the building in which the node lies.

14. The apparatus of claim 13 in which the nodes include building service device nodes (1 . . . 12, 31 . . . 38) and switching control nodes (30, 39, 102, 103).

15. The apparatus of claim 14 further including means (67) for allocating each service device node (31 . . . 38) to at least one associated switching control node (30, 39) based on the respective room assignments.

16. The apparatus of claim 15 in which the means (67) for allocating includes means (68) for programming each node (31 . . . 34, 37, 38) of a first group of service device nodes in a first room to respond to a first switching control node (39) and for programming each node (35, 36) of a second group of service device nodes in a second room to respond to a second switching control node (30).

17. The apparatus of claim 15 in which the means (67) for allocating includes means (68) for programming a first switching control node (39) to control each node (31 . . . 34, 37, 38) of a first group of service device nodes in a first room and for programming a second switching control node (30) to control each node (35, 36) of a second group of service device nodes in a second room.

18. The apparatus of claim 16 in which the first switching node (39) is located in the first room and the second switching node (30) is in the second room.

19. The apparatus of claim 16 in which the means (68) for programming includes means for issuing node configuration instructions to each node over the network.

20. The apparatus of claim 12 in which the comparator module (66) for determining the location of partition walls determines where the spatial separation of nodes indicated by the first map (64) is greater than the spatial separation of nodes indicated by the second map (63).

21. The apparatus of claim 12 in which each building service device nodes comprises a luminaire (104), and each switching control node comprises an on-off switch 30, 39), a dimmer controller (103), a motion sensor, or a presence sensor (102).

22. The apparatus of claim 12 in which each building service control device comprises any of a heating unit, a ventilation unit, or an air conditioning unit.
